(19) United States
(12) Patent Application Publication
(10) Pub. No.: US 2013/0180532 A1
(43) Pub. Date: Jul. 18, 2013

(54) METHOD OF MASSAGE

(71) Applicant: Valerie MONTAILLIER, Egreville (FR)

(72) Inventor: Valerie MONTAILLIER, Egreville (FR)

(21) Appl. No.: 13/724,710

(22) Filed: Dec. 21, 2012

Related U.S. Application Data
(60) Provisional application No. 61/579,933, filed on Dec. 23, 2011.

(51) Int. Cl. A61H 99/00

(52) U.S. Cl. CPC A61H 99/00
USPC 128/898

(57) ABSTRACT

A method of massaging a contracture muscle includes determining on the muscle at rest a direction on the muscle and on this direction, a preferential massage sense, and mobilizing the skin in the preferential massage sense.

### FIELD OF THE INVENTION

This invention relates to a method of massage and the uses of such method.

### BACKGROUND OF THE INVENTION

Traditional methods of massage recommend massaging the person while respecting the direction of blood circulation, and in particular massaging towards the heart.

However, the inventor has observed that when massaging a contractured muscle, the person being massaged generally felt that some skin mobilizations were painful and others were less or not painful. The inventor therefore concluded that all massaging techniques must take into account, as a priority, the close relation between the skin and the muscle when the latter is contractured, and demonstrated that the muscle contracture only disappeared with skin mobilizations that were less or not painful.

“Contractured muscle” designates a muscle which is contracted, even when at rest.

“Skin mobilization” designates any pressure, suction, traction or lifting of the skin implemented during a massage movement.

### OBJECT AND SUMMARY OF THE INVENTION The invention therefore relates to a method of massaging a contracture muscle comprising the following steps:

(i) determine on the muscle at rest a direction on the muscle and on this direction, identify a preferential massage sense, and
(ii) mobilize the skin in said sense.

Preferably, the direction is that of the muscle fiber. Alternatively, the direction may be different from that of the muscle fiber. Preferably, if the direction is different from that of the muscle fiber, it is the direction, on the surface of the skin covering the muscle, which is perpendicular to the direction of the muscle fiber.

When a single direction is defined, the massage is one-directional. This is quite rare, however. In case of muscle trauma, a multidirectional stretching is in fact generally observed.

Consequently, to best respect the contracture, step (i) of the method may comprise determination of a second direction on the muscle at rest and identification of a second preferential massage sense on this direction and step (ii) will comprise skin mobilization in the two senses identified in step (i). A first direction, then a second direction are therefore defined, the first and second directions being advantageously those defined above. In this case, the method of massage according to the invention will be two-directional, the two directions preferably being perpendicular to each other on the surface of the skin covering the muscle.

“Preferential massage sense” designates a preferential sense for the contractured muscle. On a given direction, it corresponds to choosing:
the sense least painful or not painful for the person being massaged, and/or
the “most fluid” sense as felt by the masseur and/or the person being massaged.

Advantageously therefore, the preferential massage sense is determined with the help of the person being massaged.

The most fluid sense is also designated as being the sense offering no resistance to the massage or traction of the skin. A muscle contracture is in fact the result of a trauma, for example stretching or direct shock. During such a trauma, the muscle reacts by a reflex contraction (myotatic reflex) which does not disappear when the muscle is at rest and becomes a contracture. This results in a reflex contraction in the muscle (which could be represented by a force vector) which then has a direction and a sense which can advantageously be broken down in a preferably orthonormal coordinate system, located in the plane of the skin surface covering the muscle, one of the directions being that of the muscle fibers.

The invention revealed that respecting this contraction during the massage eliminated the contracture. Similarly, it has been demonstrated that if this contraction was not respected, for example by massaging along the direction of the muscle fibers in the most painful sense, the contracture did not disappear.

The massage movements according to the invention are the usual movements practised during a massage such as effleurage, friction, stroking, kneading and/or skin rolling.

When the massage is two-directional, rotational movements can be made, rotation being defined according to the senses identified in step (i) of the method of massage according to the invention. This correlation between the preferential massage senses and the rotational movement is described in greater detail in the following examples, especially FIG. 3.

For a given trauma, muscle stretching can also be broken down into a combination of forces. For example, during a fall onto the hand, the biceps brachii of this arm stretches in extension and rotation.

Consequently, the massage according to this invention may also be multidirectional, provided that the preferential massage sense is respected in a given direction.

A contractured muscle frequently exhibits more than one trauma. In this case, the massage may respect the successive preferential senses, whether locally on the surface or in the depth of the muscle, like successive trauma layers, which must be treated one after the other.

Skin mobilization in the method of massage according to the invention can be performed manually or mechanically. Mechanically, the aim is to mobilize the skin by a machine, after performing step (i):
either completely independently, i.e. the massage movements are performed by massage heads which move automatically over the skin of the person being massaged according to a predetermined program entered on the machine.
or with the help of an operator, i.e. a massage head is guided and moved over the skin of the person being massaged by an operator. For example, a massage head performing a skin rolling movement is moved over the skin of a person being massaged by an operator, guiding said head.

The massage head(s) of the machine can be water jets. In this case, skin mobilization can be performed fully independently, for example by immersing the person being massaged in a bath ((“hydromassage bath”) or on a mattress (“hydro-jet”) equipped with jets capable of massaging the person according to a predetermined program entered in the machine, the person being immersed and the program started after determining, on the muscle at rest, at least one direction and at least one preferential massage sense as defined in step (i). Alternatively, skin mobilization can be performed by an operator (“hydrotherapist”) who directs a powerful jet of water onto the person being massaged, the person then being immersed in a bath, care of this type generally being called “underwater shower” in thalassotherapy.

The method of massage according to the invention can be performed not only on a human but also on an animal, in particular a horse or a dog.

Advantageously, the method of massage according to the invention also comprises a cream application step before skin mobilization.

The method of massage according to the invention has various applications.

According to a first application, the method according to the invention can be used to treat a contracture. The method according to the invention can therefore also be used to improve sport performance by eliminating the muscle contracture and consequently restoring correct muscle operation (contraction) with development of greater muscular force. Similarly, the method according to the invention can be used to treat muscle cramps which systematically affect contractured, traumatized muscles which are therefore more sensitive to stretching.

According to a second application, the method according to the invention can be used to prevent and/or treat stretch marks. In clinics in fact, it has been observed that stretch marks were only present on the contractured areas. It would appear that the muscle contracture creates skin “anchoring points” which become inextensible areas, resulting in the appearance of stretch marks. It has been observed in fact that stretch marks always followed the lines of force of the underlying muscles (i.e. they are perpendicular to the muscle fibers and follow the direction of muscular force developed by the contracture). Lastly, there is a clear relation between the stretch marks and the muscle contractures, as demonstrated in example 2.

According to a third application, the method according to the invention can be used to stimulate the blood circulation, in particular the arterial, venous, lymphatic and/or energetic pressure. “Energetic circulation” designates the energy circulation as considered by traditional Chinese medicine (especially acupuncture and traditional Chinese massage).

A muscle contracture may in fact lead to compression of a blood vessel but may also block the blood circulation. A valvular reflux and possibly even a capillary hyperpermeability may be entirely due to a contracture in the wall of the circulatory system, the wall being composed of smooth muscles. A contractured muscle will in fact develop a smaller contraction force (or muscular work) resulting in slow blood return with or without the presence of reflux and less resistance to capillary permeability. Compression of the circulatory system may also result in deformation of the vein, which would make the valve inefficient and cause stagnation of the blood circulation and in particular blood reflux.

Vascularisation can also be improved using the method according to the invention, in particular a lack of vascularisation or, on the contrary, excess vascularisation, with accumulation of toxins or other elements which accompany this phenomenon.

Certain skin problems can also be treated and baldness prevented and/or treated by improving vascularisation. In particular, the relation between stress and hair loss and/or the appearance of localized areas of white hair has been demonstrated. It is well known that stress increases muscular tonus and may result in localized cervical contracture. Baldness can be prevented and/or treated by improving scalp vascularisation and treating any cervical contracture (see example 3).

Similarly, venous or lymphatic edemas can be treated.

According to a fourth application, the method according to the invention can be used to treat migraines. The aim in particular is to remove the excess blood pressure in the cranial cavity resulting from cervical contractures requiring a massage towards the brain. These contractures exert a force preventing evacuation of blood from the cranial cavity.

According to a fifth application, the method according to the invention can be used to reduce fat storage. Fat may build up due to poor blood circulation (see above) and/or result from the lower energy consumption of the contractured muscle. In addition, an underlying contracture would explain the isolated build-up of fat.

Example 4 illustrates the effect of the method of massage according to the invention on blood circulation, vascularisation and fat storage.

According to a sixth application, the method according to the invention can be used to reduce cellulitis. The word “cellulitis” is the common term used to describe the inaesthetic “orange peel-like” or padded appearance of the skin. Cellulitis, a secondary sex characteristic specific to women, affects 90% of women after puberty. Unlike popular opinion, cellulitis is not related to obesity since it affects slim, normal, strong or obese women alike. It is the result of subcutaneous fat storage together with water retention and ageing of the connective tissue. Only a few high-level athletes are not affected by cellulitis, but in this case they suffer from disturbed cycles, without periods or ovulation. Cellulitis is observed mainly on the thighs, buttocks and abdomen. (see Draelos Z D and Marenus K D. Cellulite: Etiology and purported treatment. Dermatologic Surgery 1997;23:1177-1181)

By eliminating muscle contractures, in fact, oestrogens no longer accumulate in these “blockage/storage” areas. This avoids tissue engorgement due to attraction of water by the oestrogens. The gynoid/android morphotypes can be explained by the locations of the muscular blockages.

According to a seventh application, the method according to the invention can be used to fight skin ageing. It is known that numerous wrinkles, especially facial expression wrinkles, result from muscle contractions. Preferably, when treating facial wrinkles, especially to fight skin slackening or tissue sagging, the massage movements will generally be carried out downwards and towards the center of the face. This is the opposite of what is usually recommended, i.e. upwards and towards the outside of the face. These massage movements result from the preferential massage sense of the face muscles.

According to an eighth application, the method according to the invention can be used to prevent and/or treat mastodynias. “Mastodynias” designate pains in at least one breast. These mastodynias cause sharp pains, burning, cramps, painful lumps, a feeling of breast tension and/or pains in the nipple. The effects of the method according to the invention on mastodynias are described in particular in example 7.

According to a ninth application, the method according to the invention can be used to prevent a neurological pathology caused by a cerebral vascularisation fault: insufficient vascularisation (insufficient oxygenation), excess vascularisation or stagnation of toxins in the cranial cavity. In case of multiple sclerosis, as with numerous neurological pathologies, narrowing of the jugular veins has been observed, with or without blood reflux to the cranial cavity. Compression of the jugular veins and venous reflux are probably due to a muscle contracture. Similarly, in case of depression, recent studies have demonstrated that in patients suffering from chronic depression, some areas of the brain were “cold” compared with a healthy person. Some cerebral areas may malfunction due to insufficient vascularisation further to a cervical contracture. The effects of the method according to the invention on neurological disorders are described in particular in example 5 and 6.

### BRIEF DESCRIPTION OF THE DRAWINGS

The invention will be better understood from the following description, given solely by way of example and by referring to the drawings wherein:

FIG. 1 shows a traditional joint of the human body, comprising two muscles,

FIG. 2 shows a transverse cross-section of a muscle body, and

FIG. 3 shows the various possible configurations of a massage according to the invention comprising a rotational movement.

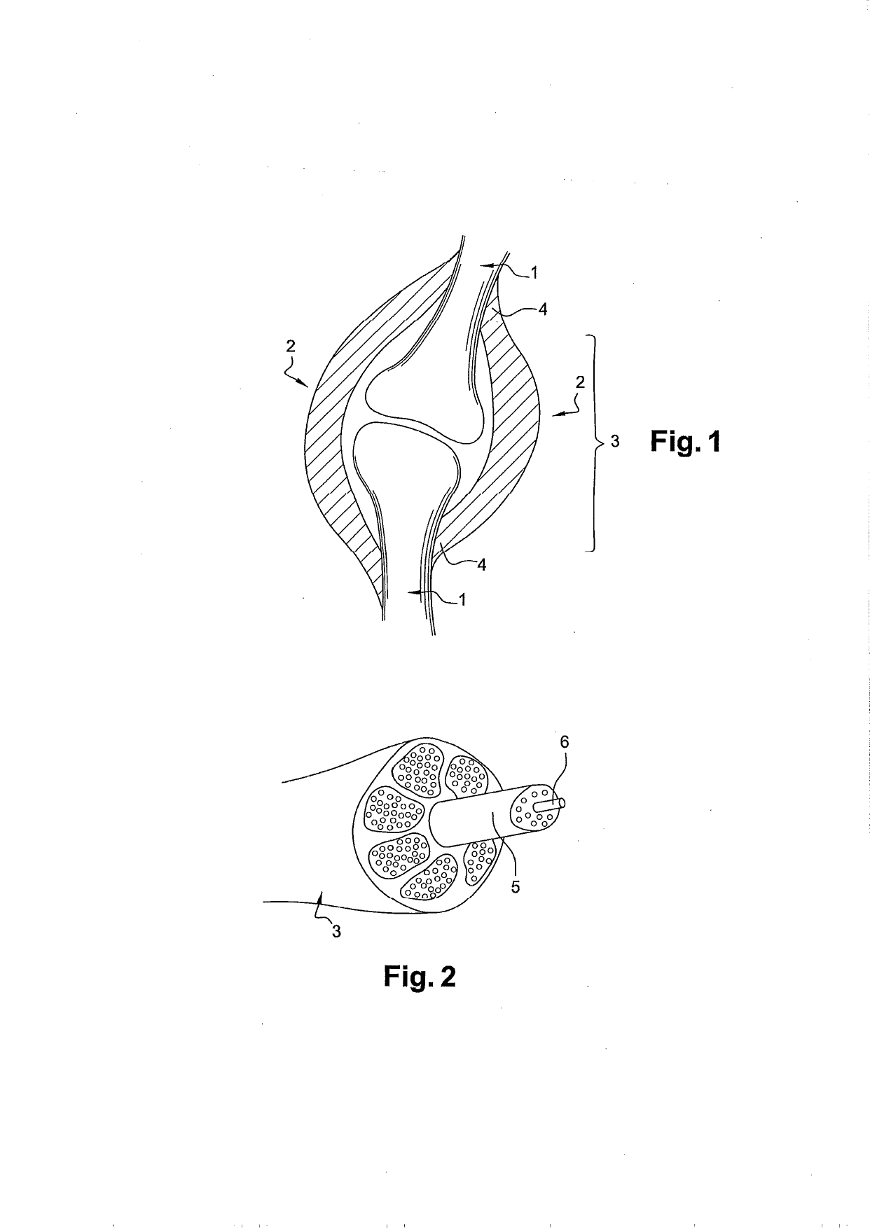

### MORE DETAILED DESCRIPTION FIG. 1 shows a joint comprising two bones 1, two “antagonistic” muscles 2, for example striated muscles. Each muscle comprises a central part 3 called muscle body and two ends 4 for attachment to the bones, generally by tendons. A distal end and a proximal end can be defined for each muscle. In a human body, the distal end of a muscle is defined as the end farthest from the heart while the proximal end is defined as the end nearest to the heart.

FIG. 2 shows a transverse cross-section of a muscle body 3. The muscle body 3 is composed of muscle bundles 5, themselves composed of muscle fibers 6.

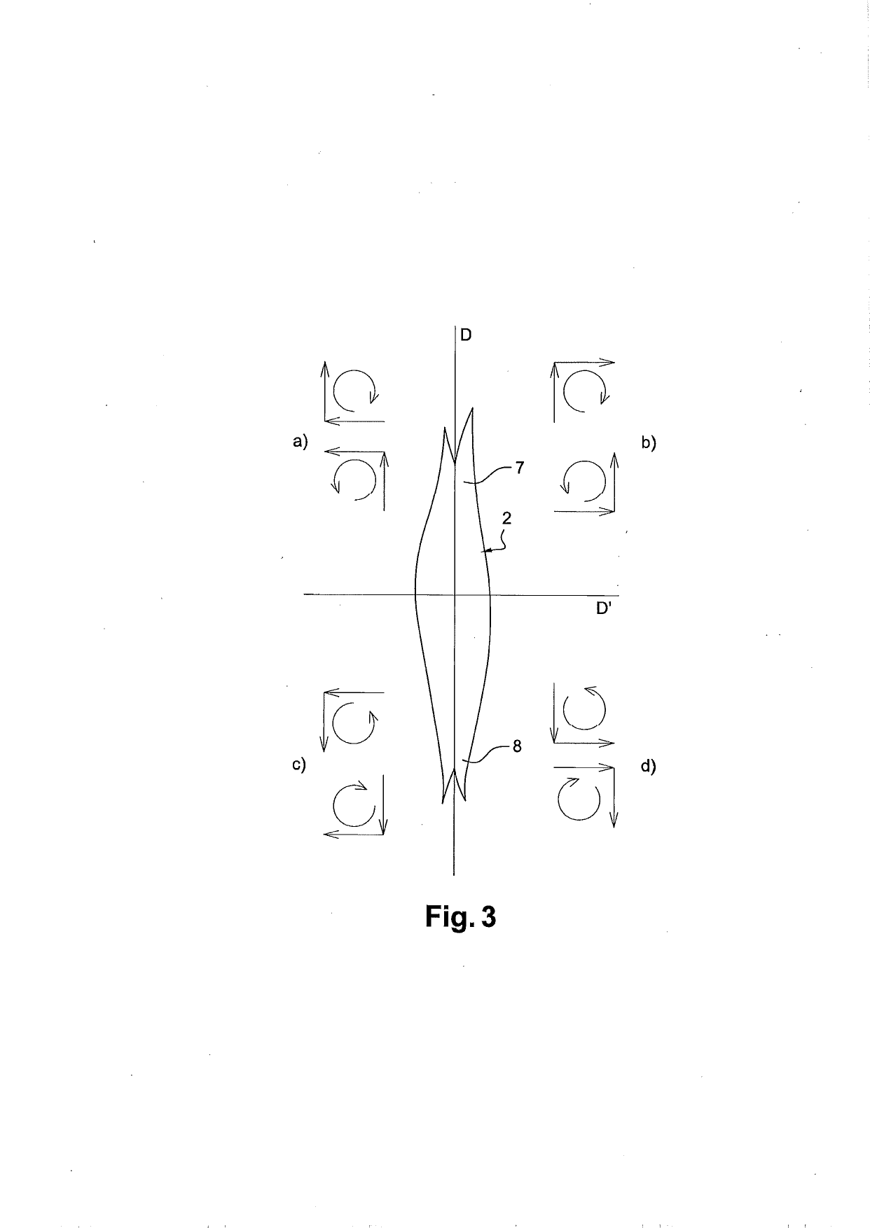

FIG. 3 shows a muscle 2, comprising a muscle body and two ends, a proximal end 7 and a distal end 8. For example, if we consider that the muscle 2 is a tibialis anterior muscle, the proximal end 7 of the muscle 2 will be the end close to the knee while the distal end 8 will be the end close to the foot.

Direction D, on the surface of the skin of the person being massaged, represents the general direction of the muscle fibers. Two senses can be defined on this direction D: one defined as going to the proximal end 7 of the muscle 2 (“upwards” sense) and the other defined as going to the distal end 8 (“downwards” sense).

Direction D′ is perpendicular to direction D. Two senses can also be defined on this direction D: the sense resulting from a clockwise 90° rotation of the “upwards” sense (sense called “towards the right”) and the sense resulting from an anticlockwise 90° rotation of the “upwards” sense (sense called “towards the left”).

After determining these two directions and these four senses, the preferential massage sense(s) on one direction and/or the other direction must be identified, possibly with the help of the person being massaged.

If there is no preferential massage sense on either direction D or D′, then the massage can be one-directional. In this case, the massage will comprise movements on the direction for which there is a preferential massage sense, respecting this sense as well as possibly massage movements, on the direction for which there is no preferential massage sense, in both senses.

If, on the contrary, there is a preferential massage sense on each direction D and D′, then the massage is two-directional. In this case, the massage will comprise movements in both directions, respecting the preferential massage senses on these directions. In this case, a massage can also be carried out with rotational movements combining the two preferential massage senses. After identifying the two senses, in fact, the component of these two senses is used to define the direction of rotation of this massage movement, as illustrated on FIG. 3. Since there are two senses for each of the two directions D, D′, four cases can be identified.

It is important to note that, during the rotation of the massage movement, the main point is the sense of skin traction. The direction of rotation cannot be defined by just “clockwise” or “anticlockwise”. Depending on the masseur's position with respect to the person being massaged and his hand preference, clockwise and anticlockwise may be modified. This can be explained by the fact that the masseur wants to save energy when performing the movement and make it easier. A clockwise massage which is pleasant when the masseur is on the left of the patient becomes unpleasant when the masseur is on the right of the patient.

In the remainder of the document, an example of clockwise and anticlockwise massage has been given for each of the four cases identified.

FIG. 3a shows the case where the preferential massage sense along direction D is “upwards” and along direction D′, “to the left”. Consequently, the component of these two senses results in a direction of rotation with traction of the skin upwards and to the left.

FIG. 3b shows the case where the preferential massage sense along direction D is “upwards” and along direction D′, “to the right”. Consequently, the component of these two senses results in a direction of rotation with traction of the skin upwards and to the right.

FIG. 3c shows the case where the preferential massage sense along direction D is “downwards” and along direction D′, “to the left”. Consequently, the component of these two senses results in a direction of rotation with traction of the skin downwards and to the left.

FIG. 3d shows the case where the preferential massage sense along direction D is “downwards” and along direction D′, “to the right”. Consequently, the component of these two senses results in a direction of rotation with traction of the skin downwards and to the right.

### Example 1

### Implementing the Massage

The person being massaged lies on a massage table. The contractured muscle is identified by palpation. Palpation is painful and a hard muscle body can be felt, generally with a particular point corresponding to exquisite pain. In addition, the masseur, and possibly the person being massaged, feel resistance to the massage.

Alternatively, a contracture may also be identified by contraction of the muscle causing pain, or by stretching, revealing hypoextensibility of the muscle with pain and limited amplitude.

In a first step, along direction D of the muscle fibers, the masseur asks the person being massaged whether he/she has a preference between traction of the skin towards the distal end or towards the proximal end of the muscle concerned. This step will identify the non-painful or least painful sense for the person being massaged and/or the most fluid sense (also designated as the sense with no resistance to massage or to traction of the skin), as felt by the masseur and/or the person being massaged along direction D.

In a second step, the masseur asks the person being massaged whether he/she prefers traction of the skin (orthogonal to the direction of the muscle body) directed towards the right side or the left side of the muscle. This step will identify the non-painful or least painful sense for the person being massaged and/or the most fluid sense (also designated as the sense with no resistance to massage or to traction of the skin), as felt by the masseur and/or the person being massaged along direction D′.

These 2 steps are used to determine the preferential massage senses along directions D and D′. Depending on the result of these two steps, and as described above, the massage will be one- or two-directional, with or without rotational massage movements.

The massage movements can be varied: effleurage, friction, stroking, kneading and skin rolling, the only restriction being to respect the preferential massage sense.

### Example 2

### Treatment of Stretch Marks

A woman was examined, presenting stretch marks on the abdomen that were much wider and more widely spaced on the left side than the right side of her abdomen. The current explanation of stretch marks based on a problem of skin elasticity is not sufficient in this case. However, it is explained by the presence of contractures of different degree on each side of the abdomen.

A 23-year old man complaining of back pains also presents stretch marks at the seventh spinal process, an unlikely location for fat storage, especially since this young man has always been thin. Fat storage is often invoked in the appearance of stretch marks due to the resulting skin stretching: fat is located between the skin and the muscle, thereby adding to the skin anchoring force due to the contracture a second resistance to skin deformation. We therefore observe more pronounced stretch marks on fat storage areas. However, this location (7^{th} spinal process) is unlikely for fat storage. This explanation is therefore not valid, unlike that of a local muscle contracture.

The skin of a 30-year old woman presenting no stretch marks on arrival to the maternity ward was torn during the muscular contractions of delivery. A 35-year old woman who had been suffering from lumbar-buttock pains for years, 8 and a half months pregnant (the baby weighed 4.25 kg at birth) with a very large stomach, presents no stretch marks on her stomach (even after delivery) while stretch marks can be observed on the lumbar region and the buttocks present before pregnancy although she never weighed more than 50 kg for a height of 1.65 m. Once again in this case, a skin quality problem cannot account for the presence of stretch marks, since the stomach skin had been stretched considerably.

Firstly, massage according to the invention eliminated the contracture which offered resistance to the skin. In this case, the contracture prevented, during growth, correct development of the skin.

Secondly, when this young woman came back from holidays in the sun, the lumbar-buttock stretch marks had been reduced considerably, although generally after sunbathing, stretch marks are more pronounced. It is likely that after massaging the contractures, the basal skin cells, subjected to lower forces, suffer less tearing and the stretch marks are attenuated by simple peeling of the skin.

### Example 3

### Scalp Vascularisation

The hair of a 44-year old man which was completely white turned gray further to a massage of cervical muscles according to the method of the invention. The treatment of cervical contractures therefore improved scalp vascularisation and produced a naturally pigmented color.

### Example 4

### Massage of a Gynoid Type Patient

In practice, it has been observed that a gynoid type patient prefers being massaged on the legs towards the feet/downwards and not towards the heart, which is nevertheless recommended and taught by the medical world.

After being massaged according to the method of the invention during 10 to 25 sessions lasting 45 min each (the frequency depending on the patient), the results are as follows:
relief or a feeling of well-being in the legs is felt immediately,
any cramps disappear,
a centimetric reduction related to the elimination of edema probably due to the accumulation (related to muscular blockage) of oestrogens (responsible for water retention) and fat storage as well as a modification of her morphology with accentuation of her muscular shapes are observed,
a development of her muscular force can be measured.

### Example 5

### Massage of Depressive Patients

Numerous patients massaged on the cervical vertebrae stopped their antidepressant treatment (especially Prozac) on their own initiative. Some described the effects as “better cerebral oxygenation”.

### Example 6

### Massage of a Patient Presenting Neurological Disorders

Tom, a 6-year old boy, suffers from Dravet syndrome with pre-autistic syndrome, spasticity, cerebellar gait and a worsening condition. At birth, Tom's umbilical cord was wrapped three times around his neck, he was delivered by Caesarean section while he was already engaged in the pelvis. His cervical muscles therefore suffered during delivery. His condition has improved since the cervical muscles have been massaged according to the method of the invention. Dribbling at the mouth has virtually stopped, his spasticity has decreased, his balance and gait have improved considerably and communication, in particular, has been radically improved: emotions such as laughing, sadness and disagreement have appeared. This suggests that these neurobiological disorders would be the result of a vascular problem.

### Example 7

### Massage of Patients Presenting a Mastodynia

Numerous women have observed that breast pains disappeared completely after massage according to the invention of the pectoral, serratus anterior and inter-costal muscles (with or without massage of the overlying mammary gland). On average, this result was obtained after 10 to 20 massage sessions lasting 45 min.

In this application, the massage is generally concentric around the areola. Concentric designates a massage directed towards the mammary areola. The massage according to the invention also eliminates any volume asymmetries of the breasts which may be observed. The breasts generally feel less heavy, present greater areolar contractility and some women whose nipples had become inverted with age recovered normal nipples. It has also been observed that mammary calcifications and mastoses may also disappear.

What is claimed is:

1. Method of massaging a contractured muscle comprising the following steps:
(i) determine on the muscle at rest a direction on the muscle and on this direction, identify a preferential massage sense, and
(ii) mobilize the skin in said sense.

2. The method according to claim 1, wherein the massage is one-directional.

3. The method according to claim 2, wherein the direction is that of the muscle fiber.

4. The method according to claim 2, wherein the direction is different from that of the muscle fiber.

5. The method according to claim 1, wherein the massage is two-directional, step (i) in this case comprising determination of a second direction on the muscle at rest and identification of a second preferential massage sense on this direction and step (ii) comprising skin mobilization in the two senses identified in step (i).

6. The method according to claim 5, wherein the massage comprising rotational movements, rotation being defined according to the senses identified in step (i).

7. The method according to claim 1, wherein the massage movements comprise effleurage, friction, stroking, kneading and/or skin rolling.

8. The method according to claim 1, wherein skin mobilization is performed manually or mechanically, in particular using water jet(s).

9. The method according to claim 1, comprising application of a cream.

10. The method according to claim 1 to treat a contracture, prevent and/or treat stretch marks, stimulate blood circulation, reduce fat storage and/or cellulitis, fight skin ageing, prevent and/or treat baldness, prevent and/or treat breast mastoses, treat venous or lymphatic edemas, improve vascularisation, treat migraines or, improve sport performance.
